(19) United States
(12) Patent Application Publication
(10) Pub. No.: US 2025/0219803 A1
(43) Pub. Date: Jul. 3, 2025

(54) TRANSMISSION PROCESSING METHOD AND APPARATUS, AND DEVICE

(71) Applicant: VIVO MOBILE COMMUNICATION CO., LTD., Dongguan (CN)

(72) Inventors: Dongru LI, Dongguan (CN); Kai WU, Dongguan (CN)

(21) Appl. No.: 19/086,556

(22) Filed: Mar. 21, 2025

Related U.S. Application Data
(63) Continuation of application No. PCT/CN2023/118953, filed on Sep. 15, 2023.

(30) Foreign Application Priority Data
Sep. 22, 2022 (CN) 202211160698.4

(51) Int. Cl. H04L 5/14; H04W 72/0453

(52) U.S. Cl. CPC H04L 5/14; H04W 72/0453

(57) ABSTRACT

This application discloses a transmission processing method and apparatus. The method includes: obtaining, by a first device, a frequency domain resource. The frequency domain resource is located in at least one type of the following frequency bands: an uplink frequency band for frequency division duplex, a supplementary uplink frequency band, and an ultra high-frequency frequency band. The method further includes: performing, by the first device, first transmission on the frequency domain resource. The first transmission includes at least one of: transmission of a control command; transmission of a carrier wave signal; and transmission of backscatter information.

### CROSS-REFERENCE TO RELATED APPLICATIONS

This application is a bypass continuation of International Application No. PCT/CN2023/118953, filed on Sep. 15, 2023, which claims priority the benefit of and priority to Chinese Patent Application No. 202211160698.4, filed on Sep. 22, 2022, the contents of both of which being incorporated by reference in their entireties herein.

### TECHNICAL FIELD

This application relates to the field of communication technologies and, specifically, relates to a transmission processing method and apparatus, and a device.

### BACKGROUND

In backscatter communication (Backscatter Communication, BSC), a backscatter communication device performs signal modulation using a radio frequency signal in another device or an environment, and implements information transmission by backscatter. In addition, some semi-passive or active backscatter communication devices may alternatively autonomously perform signal transmission without being triggered by the radio frequency signal in the another device or the environment.

When faced with various scenarios, such as large-scale user access, high power consumption, and a high throughput, that are presented in a wireless network, BSC can satisfy requirements of transmission and energy consumption reduction. However, because a capability of the backscatter communication device is limited, a passive backscatter communication device can be powered using merely an external excitation signal and thereby perform backscatter. This requires a receive end device to have a capability of supporting simultaneous sending and receiving (sending an excitation signal and receiving feedback of a tag (Tag) simultaneously). In conventional backscatter communication, a transmitting frequency is close to a receiving frequency, and a receive end faces a serious sending and receiving self-interference problem when receiving.

### BRIEF SUMMARY

Embodiments of this application provide a transmission processing method and apparatus, and a device, which can resolve a problem of how to deploy frequency domain resource allocation for BSC in an NR system.

According to a first aspect, a transmission processing method is provided, including:
obtaining, by a first device, a frequency domain resource, where the frequency domain resource is located in at least one type of the following frequency bands: an uplink frequency band for frequency division duplex, a supplementary uplink frequency band, and an ultra high-frequency frequency band; and
performing, by the first device, first transmission on the frequency domain resource, where the first transmission includes at least one of the following:
transmission of a control command;
transmission of a carrier wave signal; and
transmission of backscatter information.

According to a second aspect, a transmission processing apparatus is provided. The apparatus is used in a first device and includes:
a first obtaining module, configured to obtain a frequency domain resource, where the frequency domain resource is located in at least one type of the following frequency bands: an uplink frequency band for frequency division duplex, a supplementary uplink frequency band, and an ultra high-frequency frequency band; and
a first transmission module, configured to perform first transmission on the frequency domain resource, where the first transmission includes at least one of the following:
transmission of a control command;
transmission of a carrier wave signal; and
transmission of backscatter information.

According to a third aspect, a transmission processing method is provided, including:
obtaining, by a tag device, a frequency domain resource, where the frequency domain resource is located in at least one type of the following frequency bands: an uplink frequency band for frequency division duplex, a supplementary uplink frequency band, and an ultra high-frequency frequency band; and
performing, by the tag device, first transmission on the frequency domain resource, where the first transmission includes at least one of the following:
transmission of a control command;
transmission of a carrier wave signal; and
transmission of backscatter information.

According to a fourth aspect, a transmission processing apparatus is provided. The apparatus is used in a tag device and includes:
a second obtaining module, configured to obtain a frequency domain resource, where the frequency domain resource is located in at least one type of the following frequency bands: an uplink frequency band for frequency division duplex, a supplementary uplink frequency band, and an ultra high-frequency frequency band; and
a second transmission module, configured to perform first transmission on the frequency domain resource, where the first transmission includes at least one of the following:
transmission of a control command;
transmission of a carrier wave signal; and
transmission of backscatter information.

According to a fifth aspect, a terminal is provided, including a processor and a memory, where the memory stores a program or instructions runnable on the processor, and when the program or the instructions are executed by the processor, the steps of the method according to the first aspect or the third aspect are implemented.

According to a sixth aspect, an terminal is provided, including a processor and a communication interface, where the processor is configured to obtain a frequency domain resource, where the frequency domain resource is located in at least one type of the following frequency bands: an uplink frequency band for frequency division duplex, a supplementary uplink frequency band, and an ultra high-frequency frequency band; and the communication interface is configured to perform a first transmission on the frequency domain resource, where the first transmission includes at least one of the following:
transmission of a control command;
transmission of a carrier wave signal; and
transmission of backscatter information.

According to a seventh aspect, a network side device is provided, including a processor and a memory, where the memory stores a program or instructions runnable on the processor, and when the program or the instructions are executed by the processor, the steps of the method according to the first aspect are implemented.

According to an eighth aspect, a network side device is provided, including a processor and a communication interface, where the processor is configured to obtain a frequency domain resource, where the frequency domain resource is located in at least one type of the following frequency bands: an uplink frequency band for frequency division duplex, a supplementary uplink frequency band, and an ultra high-frequency frequency band; and the communication interface is configured to perform a first transmission on the frequency domain resource, where the first transmission includes at least one of the following:
transmission of a control command;
transmission of a carrier wave signal; and
transmission of backscatter information.

According to a tenth aspect, a non-transitory readable storage medium is provided, where the non-transitory readable storage medium stores a program or instructions, and when the program or instructions are executed by a processor, the steps of the method according to the first aspect, or the steps of the method according to the third aspect are implemented.

According to a eleventh aspect, a chip is provided, where the chip includes a processor and a communication interface, the communication interface is coupled to the processor, and the processor is configured to run a program or instructions to implement the method according to the first aspect, or implement the method according to the third aspect.

According to a twelfth aspect, a computer program/program product is provided, where the computer program/program product is stored in a storage medium, and the computer program/program product is executed by at least one processor to implement the steps of the method according to the first aspect or the third aspect.

### BRIEF DESCRIPTION OF THE DRAWINGS

FIG. 1 is a block diagram of a wireless communication system;

FIG. 2 is a first schematic flowchart of a transmission processing method according to an embodiment of this application;

FIG. 3 is a schematic diagram of frequency domain resource allocation;

FIG. 4 is a second schematic flowchart of a transmission processing method according to an embodiment of this application;

FIG. 5 is a first schematic module diagram of a transmission processing apparatus according to an embodiment of this application;

FIG. 6 is a second schematic module diagram of a transmission processing apparatus according to an embodiment of this application;

FIG. 7 is a structural block diagram of a communication device according to an embodiment of this application;

FIG. 8 is a structural block diagram of a terminal according to an embodiment of this application; and

FIG. 9 is a structural block diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some of the embodiments of this application rather than all of the embodiments. All other embodiments derived by a person of ordinary skill in the art based on the embodiments of this application shall fall within the protection scope of this application.

In the specification and claims of this application, the terms “first”, “second”, and the like are used to distinguish between similar objects, but are not used to describe a specific sequence or order. It should be understood that the terms used in such a way are interchangeable in proper circumstances, so that the embodiments of this application can be implemented in other sequences than the sequences illustrated or described herein. In addition, the objects distinguished through “first” and “second” are generally of a same type, and a quantity of objects are not limited, for example, a first object may be one or more than one. In addition, “and/or” in this specification and the claims represents at least one of the connected objects, and a character “/” used herein indicates an “or” relationship between associated objects.

It is to be noted that the technologies described in the embodiments of this application are not limited to a long term evolution (Long Term Evolution, LTE)/LTE-advanced (LTE-Advanced, LTE-A) system, and may be further applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency-division multiple access (Single-carrier Frequency-Division Multiple Access, SC-FDMA), and other systems. The terms “system” and “network” in the embodiments of this application are often used interchangeably, and the technologies described can be applied to the systems and radio technologies mentioned above, and can also be applied to other systems and radio technologies. The following exemplarily describes a new radio (New Radio, NR) system, and NR terms are used in most of the descriptions below. However, these technologies can also be applied to applications other than NR system applications, for example, a 6th generation (6th Generation, 6G) communication system.

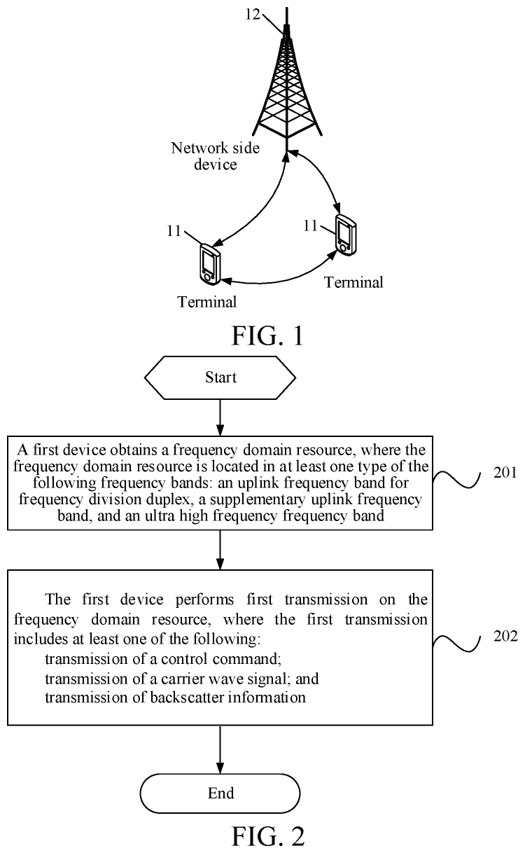

FIG. 1 is a block diagram of a wireless communication system to which an embodiment of this application is applicable. The wireless communication system includes a terminal 11 and a network side device 12. The terminal 11 may be a terminal side device, such as a mobile phone, a tablet personal computer (Tablet Personal Computer), a laptop computer (Laptop Computer), alternatively referred to as a notebook computer, a personal digital assistant (Personal Digital Assistant, PDA), a handheld computer, a netbook, an ultra-mobile personal computer (Ultra-Mobile Personal Computer, UMPC), a mobile Internet device (Mobile Internet Device, MID), an augmented reality (Augmented Reality, AR)/virtual reality (Virtual Reality, VR) device, a robot, a wearable device (Wearable Device), vehicle user equipment (Vehicle User Equipment, VUE), pedestrian user equipment (Pedestrian User Equipment, PUE), a smart household (a home device, such as a refrigerator, a TV, or a washing machine, or furniture, with a wireless communication function), a game console, a personal computer (Personal Computer, PC), a teller machine, or an automated machine. The wearable device includes: a smart watch, a smart hand ring, a smart headset, smart glasses, smart jewelry (a smart bangle, a smart bracelet, a smart ring, a smart necklace, a smart ankle bangle, a smart anklet, or the like), a smart wristband, smart clothing, and the like. It is to be noted that, a specific type of the terminal 11 is not limited in the embodiments of this application. The network side device 12 may include an access network device or a core network device. The access network device may also be referred to as a radio access network device, a radio access network (Radio Access Network, RAN), a radio access network function, or a radio access network unit. The access network device may include a base station, a wireless local area network (Wireless Local Area Network, WLAN) access point, a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BBS), an extended service set (Extended Service Set, ESS), a home NodeB, a home evolved NodeB, a transmitting receiving point (Transmitting Receiving Point, TRP), or any proper term in the field, provided that the same technical effects can be reached. The base station is not limited to a specific technical word. It is to be noted that, only a base station in an NR system is used as an example for description in the embodiments of this application, and a specific type of the base station is not limited.

For ease of understanding, some content involved in the embodiments of this application are described below.

### 1. Backscatter Communication (Backscatter Communication, BSC) or Passive Internet of Things (Passive IoT) Communication

The backscatter communication means that a backscatter communication device performs signal modulation by using a radio frequency signal in another device or an environment to transmit information of the backscatter communication device.

The backscatter communication device may be:
(1) a backscatter communication device in conventional radio frequency identification (Radio Frequency Identification, RFID), where the backscatter communication device is generally a tag (Tag) and belongs to a passive-IoT (Passive-IoT) device;
(2) a semi-passive (semi-passive) tag, where this type of tag has a specific amplification capability for downlink reception or uplink reflection; or
(3) a tag (active tag) having an actively sending capability, where this type of tag can send information to a base station (gNB) or a reader (reader) without relying on reflection of an incident signal.

In a simple implementation, when a tag needs to send “1”, the tag reflects an incident carrier wave signal. When the tag needs to send “0”, the tag does not perform reflection.

The backscatter communication device controls a reflection coefficient T of a circuit by adjusting an internal impedance of the backscatter communication device, to change an amplitude, a frequency, a phase, and the like of the incident signal, and implement modulation of the signal. A reflection coefficient of the signal may be represented as:

$$Γ = \frac{{Z}_{1} - {Z}_{0}}{{Z}_{1} + {Z}_{0}} = \vert Γ \vert {e}^{j {θ}_{T}} ,$$

where Z₀ is an antenna characteristic impedance, and Z₁ is a load impedance. If the incident signal is Sᵢₙ(t), an outputted signal is

$${S}_{out} ( t ) = {S}_{i n} ( t ) \vert Γ \vert {e}^{j {θ}_{T}} .$$

Therefore, corresponding amplitude modulation, frequency modulation, or phase modulation can be implemented by properly controlling the reflection coefficient.

Optionally, a tag device described in the embodiments of this application is the foregoing backscatter communication device.

Optionally, in the embodiments of this application, first transmission may be relevant transmission in the backscatter communication.

In the embodiments, the backscatter communication includes the following content transmission:

(1) Transmission of an excitation carrier wave (carrier wave, CW), namely, transmission of a carrier wave signal. In an embodiment, the excitation carrier wave may be sent by a network side device to a tag (tag), or may be sent by a terminal to a tag.

(2) Transmission of a control command (command), for example, a select command, a query command, a query repeat command, a reply command, a read command, a write command, or a random request command. In an embodiment, the control command may be sent by a network side device to a tag (tag), or may be sent by a terminal to a tag.

Optionally, the control command may include at least one of the following: a select type command, a query type command, and an access command, where the select type command includes at least one of the following: a select command (a specific select command), an inventory command, and an ordering command; the query type command includes at least one of the following: the query command (a specific query command), a query adjust command, and the query repeat command; and the access command includes at least one of the following: the random request command, the read command, the write command, a kill command, a lock command, a visit command, a security-related access command, and a file management-related access command.

The select (Select) type command is necessary. Because the tag has a plurality of attributes, the select type command is used based on a standard and a strategy set by a user. A specific tag group is artificially selected or circled through a change of some attributes and signs, on which merely an inventory identification or access operation may be performed, thereby facilitating reduction of a conflict and repeat identification, to increase an identification speed.

A command at an inventory stage is used for starting an inventory. For example, the query command is used for starting a round of inventory and determining which tags participate in the round of inventory; the query adjust command is used for adjusting a quantity of original receiving slots (Slots) of the tag; and the query repeat command is used for reducing a number of the Slot of the tag.

In the access (Access) command, the random request (Req_RN) command requests the tag to generate a random number; the read command is used for reading data from a specific location in storage of the tag; the write command is used for writing data into storage of the tag; the kill command may avoid leakage of privacy, and the tag can no longer be used; the lock command is used for that the tag cannot perform a writing action again, to prevent data from being arbitrarily changed; the visit command is used for converting the tag from an open (Open) state to a secure (Secure) state when the tag has a password; the security-related access command is used for ensuring tag security; and the file management-related access command may be used for managing a file in the tag.

(3) Transmission of backscatter information, which may alternatively be understood as transmission of backscatter information in the backscatter communication. The backscatter information includes, for example, Tag identification information (for example, a 16-bit random number temporarily representing an identity of the Tag in a query process), electronic product code information, and status information of the Tag. In an embodiment, a backscatter channel or signal may be sent by a tag to a terminal by backscatter, or may be sent by a tag to a network side device by backscatter.

### 2. Control Command

Transmission of the control command includes at least one of the following operations, and each operation includes one or more relevant control commands.

a. Select (Select) Operation

A process in which a reader selects a tag group for a subsequent inventory or encrypts a tag group for subsequent authentication. The select operation includes the select command.

b. Inventory (Inventory) Operation

A process in which a reader identifies a tag. The reader sends a query command through one of four sessions to start an inventory loop. One or more tags may reply. The reader detects a single tag response, and requests protocol control (protocol control, PC), an optional request extended protocol control (extended Protocol Control, XPC) word, electronic product code (Electronic Product Code, EPC), and a cyclical redundancy check (Cyclical Redundancy Check-16, CRC-16). An inventory includes a plurality of commands. An extremely important command is a challenge command. Refer to Table 2 below for details.

c. Access (Access) Operation

A process in which a reader transacts (participates by reading, writing, authorizing, or another manner) with a single tag. Before accessing, the reader identifies a tag separately. The access includes a plurality of commands.

An instruction performed by the reader is shown in Table 1, and an operation type is shown in Table 2.

TABLE 1

| | A period started by a query command and ended by a subsequent query |
|---|---|
| Inventory | command (simultaneously starting a new round of inventory process), a select |
| period | command, or a challenge command. |
| Q | A parameter used by a reader for adjusting a tag response probability. The |
| | reader indicates a tag in an inventory round to load a Q-bit random (or |
| | pseudo-random) number into a Q counter of the tag; and the reader may |
| | alternatively instruct the tag to reduce the Q counter of the tag. When a value |
| | (namely, Q) in the Q counter of the tag is zero, the tag replies. Q is an integer |
| | within a range (0, 15); and a range of a corresponding tag response probability is |
| | from 2⁰ = 1 to 2⁻¹⁵ = 0.000031. |
| | It may be understood that a quantity of tags in one inventory is controlled by |
| | using the value Q. |
| slot | A slot corresponds to a point that is in an inventory and to which a tag may |
| | respond. The Slot is a value outputted by a slot counter of a tag; and the tag |
| | replies when a slot (namely, a value in the slot counter) of the tag is zero. Refer |
| | to Q. |
| | The slot is a value randomly selected from 0 to (2^{Q} − 1) based on the value Q by |
| | the tag. Only when a specific slot value is selected, for example, slot = 0, the tag |
| | can further receive a next command. |

Specifically, the control command may include instructions shown in Table 2 (a comparison table of control commands and function descriptions).

TABLE 2

| Operation type | Instruction | Function |
|---|---|---|
| Select operation | Select (Select) | Select a tag. Allow an interrogator to select tag |
| | | filling for subsequent checking |
| | Challenge (Challenge) | The challenge allows an interrogator to challenge |
| | | tag filling for subsequent authentication. |
| Inventory | Query (Query) | Start an inventory |
| (Inventory) | | The query starts a round of inventory, and |
| operation | | determines which tags participate in the round of |
| | | inventory. |
| | | The query includes a slot-count parameter Q. |
| | | When a query participating tag is received, a |
| | | random value within a range (0, 2^{Q} − 1) is |
| | | selected, and the value is loaded into a slot |
| | | counter of the tag. A tag indicating to select zero |
| | | to transition to a reply state, and immediately |
| | | reply. A tag indicating a non-zero value to |
| | | transition to an arbitration state, and wait for a |
| | | QueryAdjust or QueryRep command |
| | Query adjust (Query | Adjust an original quantity of slots of a tag |
| | Adjust) | |
| | QueryRep (QueryRep) | A number of slots of a tag is reduced |
| | EPC answer (ACK) | An instruction that a reader replies to a tag |
| | | indicates that the Tag is to backscatter RN16. |
| | Negative | An instruction sent by a reader |
| | acknowledgement | A tag is back to an arbitrate (Arbitrate) state |
| | (NAK) | At any time, an interrogator can send a NAK. As |
| | | a response, all tags that receive the NAK in a |
| | | round of inventory are back to arbitration without |
| | | changing inventory signs of the tags. |
| Access | Random request | Request a tag to generate a random number |
| | (Req_RN) | |
| | Read (Read) | Read data from a location in storage of a tag |
| | Write (Write) | Write data into storage of a tag |
| | Kill (Kill) | No response is made to any reader anymore |
| | | Prevent leakage of privacy |
| | | A tag can no longer be used |
| | Lock (Lock) | A tag can no longer perform a writing action |
| | | Prevent data from being arbitrarily changed |
| | Access (Access) | A tag is caused to change from an open (Open) |
| | (optional) | state to a secure (Secure) state when the tag has a |
| | | password |
| | Block write | Write into a plurality of blocks at a time |
| | (BlockWrite) (optional) | |
| | Block erase | Clear a plurality of blocks in storage of a single |
| | (BlockErase) (optional) | tag |
| | Authenticate | Security-related access commands |
| | (Authenticate), | The Authenticate command may implement a |
| | SecureComm | tag, an interrogator, and/or mutual authentication, |
| | (SecureComm), | depending on implementation of a cipher suite |
| | AuthComm, | specified by a CSI in the command by the tag. |
| | KeyUpdate | The authcom command allows authenticated |
| | (KeyUpdate), and | R => T communication. |
| | TagPrivilege | The SecureComm command allows secure R => T |
| | (TagPrivilege) | communication. |
| | | The KeyUpdate command allows an |
| | | authenticated interrogator to write or update a |
| | | key. |
| | | The TagPrivilege command allows an |
| | | interrogator to separately read or modify a limit |
| | | of authority of an access password or a key. |
| | FileOpen (FileOpen), | Access-related commands for file management |
| | FileList (FileList), | A file management visit command includes the |
| | FilePrivilege | FileOpen, the FileList, the FileSetup, and the |
| | (FilePrivilege), and | FilePrivilege. |
| | FileSetup (FileSetup) | The FileOpen command allows an interrogator to |
| | | open a file. |
| | | The FileList command allows an interrogator to |
| | | determine existence, a size, an attribute, and a |
| | | limit of authority of one or more files. |
| | | The FileSetup command allows an interrogator to |
| | | change a file type of a file currently opened |
| | | and/or adjust a size of the file currently opened. |
| | | The FilePrivilege command allows an |
| | | interrogator to read a limit of authority (see |
| | | below) granted to the file currently opened or |
| | | change the limit of authority granted to the file |
| | | currently opened to an opened state, an access |
| | | password, or a key. |
| | Req_RN, | Core access command. |
| | Read, | The core access command includes the Req_RN, |
| | Write, | the Read, the Write, the Lock, the Kill, the |
| | Lock, | access, the BlockWrite, the BlockErase, the |
| | Kill, | BlockPermalock, and the UNTRACEABLE. The |
| | Access, | Req_RN, the Read, the Write, the Lock, and the |
| | BlockWrite, | Kill are necessary. The Access, the BlockWrite, |
| | BlockErase, where | the BlockErase, the BlockPermalock, and the |
| | the several commands | Untraceable are optional. A tag may implement |
| | above have been | one or more optional commands, no matter |
| | separately written in | whether the tag supports encryption security or |
| | the foregoing Table, | file management. |
| | BlockPermalock | The Write command, the BlockWrite command, |
| | (BlockPermalock), and | and the BlockErase command allow an |
| | Untraceable | interrogator to write or erase a part of tag |
| | (Untraceable) | memory. |
| | | The Lock command and the BlockPermalock |
| | | command allow an interrogator to configure a |
| | | part of the tag memory to be changeable, |
| | | permanently writable, or non-writable. |
| | | The Untraceable command allows an interrogator |
| | | with an asserted and untraceable limit of |
| | | authority. |

A status of a tag is shown in Table 3.

TABLE 3

| Status of a tag | Description |
|---|---|
| Ready (Ready) | Not in a currently performed inventory operation |
| Arbitrate (Arbitrate) | The tag currently belongs to a specific inventory operation |
| | Represent that a number of a Slot is not yet zero, indicating remaining |
| | a waiting state |
| Reply (Reply) | Generate a 16-bit random number for a reader |
| | Enter a response state when an ACK message is received |
| | Return to an arbitrate state when no ACK message is received |
| Acknowledge | Enter any state other than a killed state from this state |
| (Acknowledge) | |
| Open (Open) | A tag whose password is not zero in an acknowledgement state enters |
| | an open state when receiving an instruction of a random request |
| Secure (Secure) | A tag whose password is zero in an acknowledgement state enters a |
| | secure state when receiving an instruction of a random request sent by |
| | a reader |
| Killed (Killed) | Permanently unavailable |

In a current protocol design of ultra high frequency radio frequency identification (Ultra High Frequency Radio Frequency IDentification, UHF RFID), in an inventory mode, it is required that after a reader sends a query (Query) instruction, a tag (Tag) responds and replies (Reply), to be specific, generates a 16-bit random number to the reader. Then, after the reader sends a sequence to the Tag through an ACK instruction, the Tag sends relevant data to the reader.

Optionally, the foregoing reader may be a first device in the embodiments.

### 3. Backscatter Communication Application Scenario

Application scenario 1: A network side device (for example, a base station) sends continuous waves (Continuous Waves, CW) and signaling, and receives an incident signal of a tag.

Application scenario 2: A terminal sends CW and signaling, and receives an incident signal of a tag.

Application scenario 3: A network side device sends CW and signaling to a Tag; and a terminal receives backscatter information sent by the Tag.

Application scenario 4: A terminal sends CW and signaling to a Tag, and a network side device receives backscatter information of the Tag.

A type of the foregoing base station includes, but is not limited to: an IAB node (IAB node), a repeater (repeater), and a pole station (Pole station). For example, the foregoing repeater may be a network controlled repeater (network controlled repeater).

A transmission processing method provided in the embodiments of this application is described in detail below with reference to the accompanying drawings through some embodiments and application scenarios thereof.

As shown in FIG. 2, an embodiment of this application provides a transmission processing method, including the following steps.

Step 201: A first device obtains a frequency domain resource, where the frequency domain resource is located in at least one type of the following frequency bands: an uplink frequency band for frequency division duplex, a supplementary uplink frequency band, and an ultra high-frequency frequency band.

The first device determines, in at least one type of frequency band of the uplink (UpLink, UL) frequency band for frequency division duplex (Frequency Division Duplex, FDD), the supplementary uplink (Supplementary UpLink, SUL) frequency band, and the ultra high frequency (Ultra High Frequency, UHF) frequency band, a frequency domain resource used in first transmission.

Step 202: The first device performs first transmission on the frequency domain resource, where the first transmission includes at least one of the following:
transmission of a control command;
transmission of a carrier wave signal; and
transmission of backscatter information.

The first transmission is backscatter transmission. The foregoing transmission of the control command, the transmission of the carrier wave signal, and the transmission of the backscatter information may be transmission on a backscatter link. For the transmission of the control command, the transmission of the carrier wave signal (or an excitation carrier wave), and the transmission of the backscatter information, reference may be made to the descriptions above, and details are not described herein again.

In this step, the first device can implement transmission of at least one of the control command, the carrier wave signal, and the backscatter information by using the frequency domain resource obtained in step 201.

In the embodiments of this application, the first transmission is performed in at least one type of frequency band of the uplink frequency band for frequency division duplex, the supplementary uplink frequency band, and the ultra high-frequency frequency band. The first transmission includes at least one of the transmission of the control command, the transmission of the carrier wave signal, and the transmission of the backscatter information. In this way, frequency domain resource allocation of the first transmission in the NR system is deployed. Because a frequency domain resource used in the first transmission is located in at least one type of frequency band of the uplink frequency band for frequency division duplex, the supplementary uplink frequency band, and the ultra high-frequency frequency band, so that NR signal transmission on a downlink spectrum is not occupied and interfered.

In this way, according to step 201 and step 202, the first device can perform the first transmission in at least one type of frequency band of the UL frequency band for FDD, the SUL frequency band, and the UHF frequency band. Because the frequency domain resource is located in at least one type of frequency band of the UL frequency band for FDD, the SUL frequency band, and the UHF frequency band, NR downlink transmission on a FDD downlink spectrum can be not occupied and interfered.

Optionally, the foregoing first transmission is full-duplex transmission.

To deploy the first transmission in an NR system and satisfy a regulatory requirement (to be specific, sending of a base station in a DL band cannot be interfered), the disclosure is designed to limit the first transmission related to passive Internet of Things (passive IoT) communication (which may also be referred to as backscatter communication) to at least one type of frequency band of the UL frequency band for FDD, the SUL frequency band, and the UHF frequency band.

Optionally, in this embodiment, the first device includes: at least one of a terminal device and a network side device.

Exemplarily, when the first device is a terminal device, the terminal device may use a duplexer (duplexer) or a radio frequency front-end design with a similar function, to implement simultaneous sending and receiving, and by performing sending and receiving on different frequency domain resources, problems of sending and receiving interference and co-frequency self-interference can be avoided. This facilitates reduction of implementation complexity, and communication performance is improved.

Optionally, in this embodiment, the control command includes at least one of the following: a select command, a query command, and an access command; and the backscatter information is the information triggered by the control command.

In other words, when the first transmission is the transmission of the control command, the first device transmits at least one of the select command, the query command, and the access command. When the first transmission is the transmission of the backscatter information, the first device transmits the information triggered by the control command.

Optionally, the select command (similar to a Select command in RFID) is used for selecting a Tag (a tag device) that satisfies one or more specified conditions.

Optionally, the query command includes: a first command (corresponding to a query in RFID), for example, a control command used for indicating a reverse transmission parameter (including a transmission rate, a modulation manner, or an encoding manner); a second command (corresponding to a QueryRep in RFID), for example, a control command used for indicating a tag to change a counting value stored in a determining process; a third command (corresponding to a queryAdjust in RFID), for example, a control command used for indicating a change of an inventory parameter, including a change of a parameter used for determining a random number range of a tag; and a fourth command, for example, a control command (for example, the foregoing ACK command) used for indicating ACK information.

Optionally, the access command is a command used for reading and writing a tag memory or changing a tag memory.

The backscatter information includes a feedback signal and a feedback channel. The feedback signal may also be understood as a signal on a feedback channel.

Optionally, in this embodiment, the control command and the carrier wave signal are sent by at least one terminal device and/or at least one network side device.

Optionally, in this embodiment, the frequency domain resource includes a first sub-frequency domain resource and a second sub-frequency domain resource, where the first sub-frequency domain resource is used for transmission of at least one of the control command and the carrier wave signal, and the second sub-frequency domain resource is used for the transmission of the backscatter information.

Further, the first device sends at least one of the control command and the carrier wave signal on the first sub-frequency domain resource, and/or the first device receives the backscatter information on the second sub-frequency domain resource.

In this way, sending and receiving of the first device can be performed on different frequency domain resources, and therefore, sending and receiving self-interference of the first device is reduced or avoided.

Optionally, in this embodiment, the first sub-frequency domain resource and the second sub-frequency domain resource are non-consecutive and/or non-overlapping.

To be specific, the first sub-frequency domain resource and the second sub-frequency domain resource are non-consecutive and/or non-overlapping on a frequency domain, to effectively reduce interference of simultaneous sending and receiving.

Optionally, a time domain resource corresponding to the first sub-frequency domain resource is the same as a time domain resource corresponding to the second sub-frequency domain resource.

Optionally, in this embodiment, the first sub-frequency domain resource and the second sub-frequency domain resource are located in a same frequency band, or the first sub-frequency domain resource and the second sub-frequency domain resource are located in different frequency bands.

In other words, sending (sending the control command and/or the carrier wave signal) and receiving (receiving the backscatter information) of the first device can be implemented in a same frequency band or different frequency bands. Certainly, when the first device sends at least one of the control command and the carrier wave signal, and/or receives the backscatter information in a plurality of frequency bands, the plurality of frequency bands may be frequency bands of a same type, or may be frequency bands of different types. For example, the first device sends the control command and/or the carrier wave signal, and receives the backscatter information in a UL frequency band 1 for FDD. Alternatively, the first device sends the control command and/or the carrier wave signal in a UL frequency band 1 for FDD, and receives the backscatter information in a UL frequency band 2 for FDD.

Exemplarily, the first transmission is performed by using two frequency bands, and the first sub-frequency domain resource and the second sub-frequency domain resource are respectively in different frequency bands.

In this embodiment, locations and sizes of the first sub-frequency domain resource and the second sub-frequency domain resource may be configured by a network side or agreed by a protocol.

Exemplarily, the first device may determine the locations and the sizes of the first sub-frequency domain resource and the second sub-frequency domain resource by obtaining resource configuration information, or determine the locations and the sizes of the first sub-frequency domain resource and the second sub-frequency domain resource based on a protocol agreement. For example, the network side device generates resource configuration information, and configures a type of a frequency band in which the frequency domain resource is located to be the UL frequency band for FDD. The first device obtains the resource configuration information, and performs the first transmission in the UL frequency band for FDD.

Optionally, a frequency domain interval between the first sub-frequency domain resource and the second sub-frequency domain resource is greater than or equal to a first threshold.

The first threshold may be preconfigured or predefined, to cause the first sub-frequency domain resource and the second sub-frequency domain resource to satisfy a frequency domain interval needed by the duplexer or satisfy a requirement of self-interference cancellation.

Optionally, a frequency of the first sub-frequency domain resource is higher than a frequency of the second sub-frequency domain resource.

Optionally, a bandwidth of the frequency band in which the frequency domain resource is located is greater than or equal to a second threshold, where the second threshold is configured by a network side or agreed by a protocol.

In other words, if there are a plurality of frequency bands used for determining the frequency domain resource, the frequency domain resource is determined in a frequency band whose bandwidth is greater than or equal to the second threshold in the plurality of frequency bands. Herein, the second threshold may be preconfigured or predefined, to cause the frequency domain resource to be enough for implementing no interference or small interference of sending and receiving.

In addition, optionally, in this embodiment, the method further includes:
the first device reports first capability information, where
the first capability information includes indication information about whether the first device supports simultaneously performing the first transmission and second transmission, where the second transmission includes new radio NR transmission and/or sidelink transmission.

In this case, the network side device can subsequently perform, based on the reported first capability information, an operation of NR transmission and/or sidelink transmission related to the first device.

Optionally, in a case that the first device supports simultaneously performing the first transmission and the second transmission, the frequency band in which the frequency domain resource is located is a con-current (con-current) operating frequency band.

The con-current operating frequency band is an inter-band con-current operating band (Inter-band con-current operating band) or an intra-band con-current operating bands (Intra-band con-current operating band).

Exemplarily, the inter-band con-current operating band is shown in Table 4, and the intra-band con-current operating band is shown in Table 5.

TABLE 4

| BSC con-current operating Band | NR or BSC Operating Band | |
|---|---|---|
| (backscatter communication | (new radio or backscatter | |
| con-current operating band) | communication operating band) | Interface (interface) |
| BSC (backscatter | Band index n | Uu (NR communication |
| communication_n-m) | | interface) |
| | Band index m | BSC communication |
| | | interface |

TABLE 5

| | NR or BSC | |
|---|---|---|
| | Operating Band | |
| BSC con-current operating | (backscatter | |
| Band (backscatter communication | communication | Interface |
| con-current operating band) | operating band) | (interface) |
| BSC (backscatter | Band index k | Uu (NR |
| communication k-k) | | communication |
| | | interface) |
| | Band index k | BSC |
| | | communication |
| | | interface |

It is to be noted that, in this embodiment, the first device and the tag device perform the first transmission. The tag device below is referred to as the tag for short.

Exemplarily, the tag is an active device or a semi-passive device; and/or the tag has a capability for a frequency shift. The frequency shift refers to the frequency shifting between a transmitting frequency and a receiving frequency. In this way, after receiving the control command and/or the carrier wave signal on the first sub-frequency domain resource, the tag needs to perform the frequency shift to send the backscatter information on the second sub-frequency domain resource. In other words, a frequency domain in which the first sub-frequency domain resource is located is switched (or shifted) to a frequency domain in which the second sub-frequency domain resource is located, and then the backscatter information is sent.

The following uses the first transmission between the first device (for example, the terminal) and the tag as an example, to describe application of the method according to the embodiments of this application.

Scenario 1: The network side device configures a first frequency band to be the UL frequency band for FDD, and the first frequency band includes the foregoing frequency domain resource. The network side device sends resource configuration information of the first frequency band, and the terminal receives the resource configuration information and obtains the frequency domain resource. Subsequently, the terminal performs the first transmission in the UL frequency band for FDD. The terminal may use a duplexer (duplexer) or a radio frequency front-end design with a similar function, to implement simultaneous sending and receiving (including simultaneous sending and receiving on different frequency domain resources).

Manner 1: The network side device configures the first frequency band, including one UL frequency band for FDD, and both the first sub-frequency domain resource and the second sub-frequency domain resource are in the UL frequency band for FDD. In the UL frequency band for FDD, the terminal sends the control command and/or the carrier wave signal, and also receives the backscatter information sent by the tag. Optionally, a bandwidth of the UL frequency band for FDD is greater than or equal to the second threshold (for example, 20 MHZ).

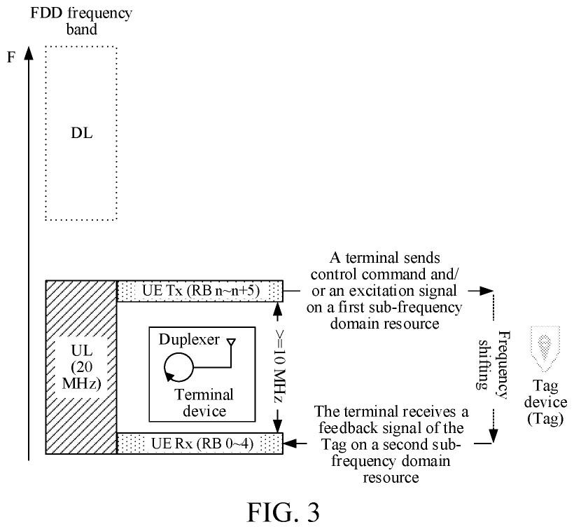

For example, as shown in FIG. 3, the network side device configures a first frequency band (the UL frequency band for FDD) whose bandwidth is equal to 20 Mhz. The first sub-frequency domain resource (UE Tx) and the second sub-frequency domain resource (UE Rx) are non-overlapping and non-adjacent. A location and size of the first sub-frequency domain resource is RB n˜n+5, where n>4; and a location and size of the second sub-frequency domain resource is RB 0˜4. For another example, if a protocol agrees that the frequency domain interval between the first sub-frequency domain resource and the second sub-frequency domain resource is greater than or equal to the first threshold (for example, 10 Mhz), a value of n needs to satisfy a difference of 10 Mhz or more between the value of n and a highest frequency RB 4 of the second sub-frequency domain resource.

Manner 2: The network side device configures the first frequency band, including two UL frequency bands for FDD, and the first sub-frequency domain resource and the second sub-frequency domain resource are respectively in the different UL frequency bands for FDD. In one UL frequency band for FDD of the two UL frequency bands for FDD, the terminal sends the control command and/or the carrier wave signal; and in the other UL frequency band for FDD of the two UL frequency bands for FDD, the terminal receives the backscatter information sent by the tag. Optionally, the frequency domain interval between the first sub-frequency domain resource and second sub-frequency domain resource is greater than or equal to the first threshold. Certainly, a frequency domain interval between the two UL frequency bands for FDD may be greater than or equal to a third threshold. The third threshold is preconfigured or predefined. For example, the third threshold is equal to the first threshold.

Scenario 2: The network side device configures a second frequency band to be a UHF frequency band (840 Mhz to 960 Mhz), and the second frequency band includes the foregoing frequency domain resource. The network side device sends resource configuration information of the second frequency band, and the terminal receives the resource configuration information and obtains the frequency domain resource. Subsequently, the terminal performs the first transmission in the UHF frequency band. The terminal may use a duplexer or a radio frequency front-end design with a similar function, to implement simultaneous sending and receiving (including simultaneous sending and receiving on different frequency domain resources).

The network side device configures the second frequency band, including one UHF frequency band, and both the first sub-frequency domain resource and the second sub-frequency domain resource are located in the UHF frequency band. In the UHF frequency band, the terminal sends the control command and/or the carrier wave signal, and also receives the backscatter information sent by the tag. Optionally, the first sub-frequency domain resource and the second sub-frequency domain resource are respectively located in different subbands (subband) of the UHF frequency band. Optionally, the different subbands are not adjacent to each other, and a frequency domain interval may be greater than or equal to a fourth threshold. The fourth threshold is preconfigured or predefined. For example, the fourth threshold is equal to the first threshold.

In conclusion, in the method according to the embodiments of this application, the first device can perform the first transmission in at least one type of frequency band of the UL frequency band for FDD, the SUL frequency band, and the UHF frequency band, and the first transmission includes at least one of the transmission of the control command, the transmission of the carrier wave signal, and the transmission of the backscatter information, to complete BSC sending and/or receiving. Because the frequency domain resource is located in at least one type of frequency band of the UL frequency band for FDD, the SUL frequency band, and the UHF frequency band, NR downlink transmission on a FDD downlink spectrum can be not occupied and interfered.

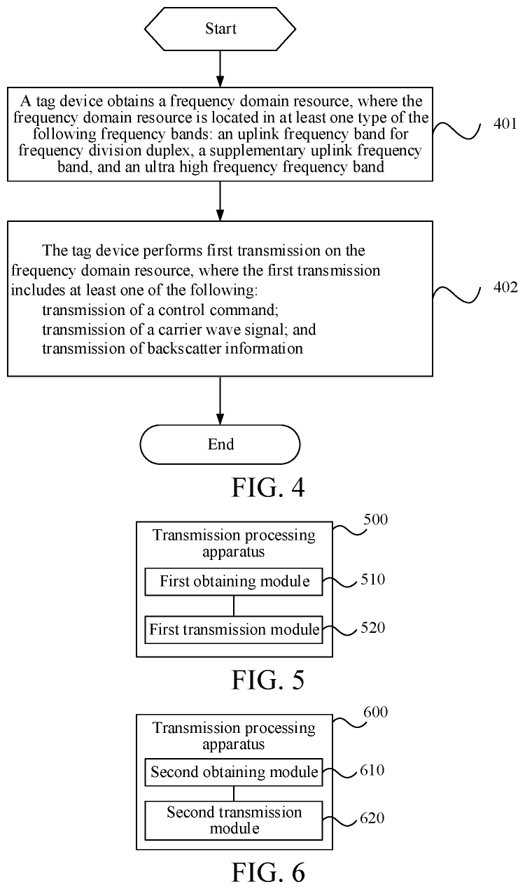

As shown in FIG. 4, an embodiment of this application provides a transmission processing method, including the following steps.

Step 401: A tag device obtains a frequency domain resource, where the frequency domain resource is located in at least one type of the following frequency bands: an uplink frequency band for frequency division duplex, a supplementary uplink frequency band, and an ultra high-frequency frequency band.

Step 402: The tag device performs first transmission on the frequency domain resource, where the first transmission includes at least one of the following:
transmission of a control command;
transmission of a carrier wave signal; and
transmission of backscatter information.

In this way, the tag device (referred to as the tag for short) can perform the first transmission in at least one type of frequency band of the UL frequency band for FDD, the SUL frequency band, and the UHF frequency band, and the first transmission includes at least one of the transmission of the control command, the transmission of the carrier wave signal, and the transmission of the backscatter information, to complete BSC sending and/or receiving. Because the frequency domain resource is located in at least one type of frequency band of the UL frequency band for FDD, the SUL frequency band, and the UHF frequency band, NR downlink transmission on a FDD downlink spectrum can be not occupied and interfered.

Optionally, the frequency domain resource includes a first sub-frequency domain resource and a second sub-frequency domain resource, where the first sub-frequency domain resource is used for transmission of at least one of the control command and the carrier wave signal, and the second sub-frequency domain resource is used for the transmission of the backscatter information.

In other words, the tag device can receive at least one of the control command and the carrier wave signal on the first sub-frequency domain resource, and/or send the backscatter information on the second sub-frequency domain resource. In this way, sending and receiving of the tag device are performed on different frequency domains, reducing mutual interference.

Optionally, the first sub-frequency domain resource and the second sub-frequency domain resource are located in a same frequency band, or the first sub-frequency domain resource and the second sub-frequency domain resource are located in different frequency bands.

Optionally, the first sub-frequency domain resource and the second sub-frequency domain resource are non-consecutive and/or non-overlapping.

Optionally, a frequency domain interval between the first sub-frequency domain resource and the second sub-frequency domain resource is greater than or equal to a first threshold.

Optionally, a frequency of the first sub-frequency domain resource is higher than a frequency of the second sub-frequency domain resource.

Optionally, a bandwidth of the frequency band in which the frequency domain resource is located is greater than or equal to a second threshold.

Optionally, the method further includes:
the tag device reports second capability information, where
the second capability information includes indication information about whether the tag device supports simultaneously performing the first transmission and second transmission, where the second transmission includes new radio NR transmission and/or sidelink transmission.

In this case, the network side device can subsequently perform, based on the reported second capability information, an operation of NR transmission and/or sidelink transmission related to the tag device.

Optionally, in a case that the tag device supports simultaneously performing the first transmission and the second transmission, a frequency band in which the frequency domain resource is located is a con-current operating frequency band, where
the second transmission includes the NR transmission and/or the sidelink transmission.

Optionally, the tag device sends the backscatter information in a backscatter manner or an actively sending manner.

Herein a difference of the backscatter manner and the actively sending manner lies in that energy sources are different. In the backscatter manner, the first device provides energy. In the actively sending manner, the tag device provides energy.

Optionally, the tag device satisfies at least one of the following:
being an active device or a semi-passive device; and
having a capability for a frequency shift, where the frequency shift refers to the frequency shifting between a transmitting frequency and a receiving frequency.

Optionally, the control command includes at least one of the following: a select command, a query command, and an access command; and the backscatter information is the information triggered by the control command.

Optionally, the control command and the carrier wave signal are sent by at least one terminal device and/or at least one network side device.

It is to be noted that, the method is implemented in cooperation with the foregoing transmission processing method performed by the first device. An implementation manner of the embodiments of the foregoing transmission processing method performed by the first device is applicable to the method and the same technical effects can be achieved.

The transmission processing method provided in this embodiment of this application may be performed by a transmission processing apparatus. In an embodiment of this application, that the transmission processing apparatus performs the transmission processing method is taken as an example for description of the transmission processing apparatus according to this embodiment of this application.

As shown in FIG. 5, an embodiment of this application provides a transmission processing apparatus, used in a first device, the apparatus including:
a first obtaining module 510, configured to obtain a frequency domain resource, where the frequency domain resource is located in at least one type of the following frequency bands: an uplink frequency band for frequency division duplex, a supplementary uplink frequency band, and an ultra high-frequency frequency band; and
a first transmission module 520, configured to perform first transmission on the frequency domain resource, where the first transmission includes at least one of the following:
transmission of a control command;
transmission of a carrier wave signal; and
transmission of backscatter information.

Optionally, the frequency domain resource includes a first sub-frequency domain resource and a second sub-frequency domain resource, where the first sub-frequency domain resource is used for transmission of at least one of the control command and the carrier wave signal, and the second sub-frequency domain resource is used for the transmission of the backscatter information.

Optionally, the first sub-frequency domain resource and the second sub-frequency domain resource are located in a same frequency band, or the first sub-frequency domain resource and the second sub-frequency domain resource are located in different frequency bands.

Optionally, the first sub-frequency domain resource and the second sub-frequency domain resource are non-consecutive and/or non-overlapping.

Optionally, a frequency domain interval between the first sub-frequency domain resource and the second sub-frequency domain resource is greater than or equal to a first threshold.

Optionally, a frequency of the first sub-frequency domain resource is higher than a frequency of the second sub-frequency domain resource.

Optionally, a bandwidth of the frequency band in which the frequency domain resource is located is greater than or equal to a second threshold.

Optionally, the apparatus further includes:
a first reporting module, configured to report first capability information, where
the first capability information includes indication information about whether the first device supports simultaneously performing the first transmission and second transmission, where the second transmission includes new radio NR transmission and/or sidelink transmission.

Optionally, in a case that the first device supports simultaneously performing the first transmission and the second transmission, a frequency band in which the frequency domain resource is located is a con-current operating frequency band.

Optionally, the first device includes: at least one of a terminal device and a network side device.

Optionally, the control command includes at least one of the following: a select command, a query command, and an access command; and the backscatter information is the information triggered by the control command.

Optionally, the control command and the carrier wave signal are sent by at least one terminal device and/or at least one network side device.

The apparatus can perform the first transmission in at least one type of frequency band of the UL frequency band for FDD, the SUL frequency band, and the UHF frequency band, and the first transmission includes at least one of the transmission of the control command, the transmission of the carrier wave signal, and the transmission of the backscatter information, to complete BSC sending and/or receiving. Because the frequency domain resource used in the first transmission is located in at least one type of frequency band of the UL frequency band for FDD, the SUL frequency band, and the UHF frequency band, NR downlink transmission on a FDD downlink spectrum can be not occupied and interfered.

The transmission processing apparatus in this embodiment of this application may be an electronic device, for example, an electronic device with an operating system, or may be a component, for example, an integrated circuit or a chip, in an electronic device. The electronic device may be a terminal or another device, or may be another device other than a terminal. Exemplarily, the terminal may include, but is not limited to the type of the terminal 11 listed above. The another device may be a server, a network attached storage (Network Attached Storage, NAS), or the like, which is not specifically limited in the embodiments of this application.

The transmission processing apparatus according to this embodiment of this application can implement all processes implemented by the method embodiments shown in FIG. 2 and FIG. 3, and the same beneficial effects are achieved. Details are not described herein again to avoid repetition.

As shown in FIG. 6, an embodiment of this application provides a transmission processing apparatus, used in a tag device, the apparatus including:
a second obtaining module 610, configured to determine a frequency domain resource, where the frequency domain resource is located in at least one type of the following frequency bands: an uplink frequency band for frequency division duplex, a supplementary uplink frequency band, and an ultra high-frequency frequency band; and
a second transmission module 620, configured to perform first transmission on the frequency domain resource, where the first transmission includes at least one of the following:
transmission of a control command;
transmission of a carrier wave signal; and
transmission of backscatter information.

Optionally, the frequency domain resource includes a first sub-frequency domain resource and a second sub-frequency domain resource, where the first sub-frequency domain resource is used for transmission of at least one of the control command and the carrier wave signal, and the second sub-frequency domain resource is used for the transmission of the backscatter information.

Optionally, the first sub-frequency domain resource and the second sub-frequency domain resource are located in a same frequency band, or the first sub-frequency domain resource and the second sub-frequency domain resource are located in different frequency bands.

Optionally, the first sub-frequency domain resource and the second sub-frequency domain resource are non-consecutive and/or non-overlapping.

Optionally, a frequency domain interval between the first sub-frequency domain resource and the second sub-frequency domain resource is greater than or equal to a first threshold.

Optionally, a frequency of the first sub-frequency domain resource is higher than a frequency of the second sub-frequency domain resource.

Optionally, a bandwidth of the frequency band in which the frequency domain resource is located is greater than or equal to a second threshold.

Optionally, the apparatus further includes:
a second reporting module, configured to report second capability information, where
the second capability information includes indication information about whether the tag device supports simultaneously performing the first transmission and second transmission, where the second transmission includes new radio NR transmission and/or sidelink transmission.

Optionally, in a case that the tag device supports simultaneously performing the first transmission and the second transmission, a frequency band in which the frequency domain resource is located is a con-current operating frequency band, where
the second transmission includes the NR transmission and/or the sidelink transmission.

Optionally, the tag device sends the backscatter information in a backscatter manner or an actively sending manner.

Optionally, the tag device satisfies at least one of the following:
being an active device or a semi-passive device; and
having a capability for a frequency shift, where the frequency shift refers to the frequency shifting between a transmitting frequency and a receiving frequency.

Optionally, the control command includes at least one of the following: a select command, a query command, and an access command; and the backscatter information is the information triggered by the control command.

Optionally, the control command and the carrier wave signal are sent by at least one terminal device and/or at least one network side device.

The apparatus can perform the first transmission in at least one type of frequency band of the UL frequency band for FDD, the SUL frequency band, and the UHF frequency band, and the first transmission includes at least one of the transmission of the control command, the transmission of the carrier wave signal, and the transmission of the backscatter information, to complete BSC sending and/or receiving. Because the frequency domain resource used in the first transmission is located in at least one type of frequency band of the UL frequency band for FDD, the SUL frequency band, and the UHF frequency band, NR downlink transmission on a FDD downlink spectrum can be not occupied and interfered.

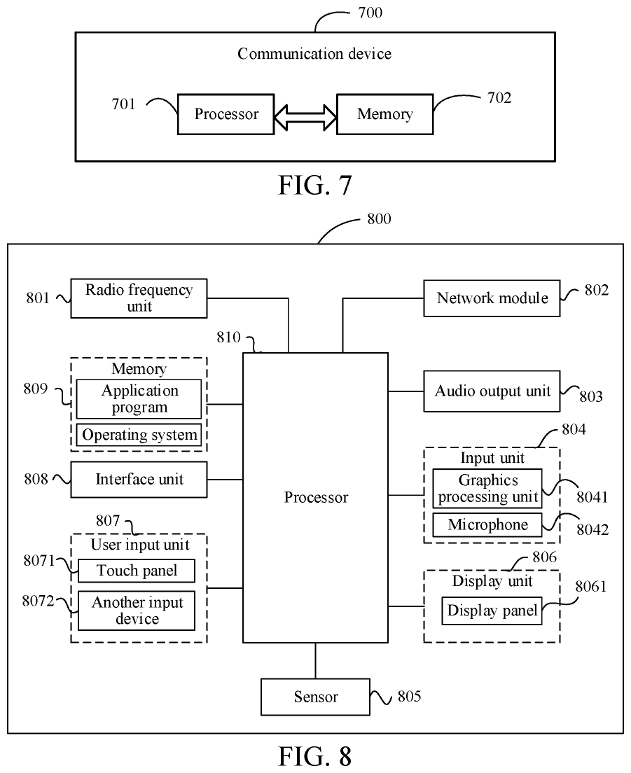

Optionally, as shown in FIG. 7, an embodiment of this application further provides a communication device 700, including a processor 701 and a memory 702. The memory 702 stores a program or instructions runnable on the processor 701. For example, when the communication device 700 is a terminal, when the program or the instructions are executed by the processor 701, each step of the foregoing transmission processing method embodiments is implemented, and the same technical effects can be achieved. When the communication device 700 is a first device, when the program or the instructions are executed by the processor 701, each process of the foregoing method embodiments of a first device side or a tag device side is implemented, and the same technical effects can be achieved. Details are not described herein again to avoid repetition.

An embodiment of this application further provides a terminal, including a processor and a communication interface, where the processor is configured to obtain a frequency domain resource, where the frequency domain resource is located in at least one type of the following frequency bands: an uplink frequency band for frequency division duplex, a supplementary uplink frequency band, and an ultra high-frequency frequency band; and the communication interface is configured to perform first transmission on the frequency domain resource, where the first transmission includes at least one of the following: transmission of a control command; transmission of a carrier wave signal; and transmission of backscatter information. The terminal embodiment corresponds to the foregoing method embodiment of the first device side, each implementation process and manner of the foregoing method embodiment is applicable to the terminal embodiment, and the same technical effects can be achieved. Specifically, FIG. 8 is a schematic diagram of a hardware structure of a terminal for implementing the embodiments of this application.

A terminal 800 includes, but is not limited to, at least a part of components of a radio frequency unit 801, a network module 802, an audio output unit 803, an input unit 804, a sensor 805, a display unit 806, a user input unit 807, an interface unit 808, a memory 809, a processor 810, and the like.

A person skilled in the art may understand that the terminal 800 may further include a power supply (such as a battery) for supplying power to the components. The power supply may be logically connected to the processor 810 by using a power management system, thereby implementing functions such as charging, discharging, and power consumption management by using the power management system. A terminal structure shown in FIG. 8 constitutes no limitation on the terminal, and the terminal may include more or fewer components than those shown in the figure, or some components may be combined, or a different component deployment may be used, which are not described herein again.

It is to be understood that, in this embodiment of this application, the input unit 804 may include a graphics processing unit (Graphics Processing Unit, GPU) 8041 and a microphone 8042, and the graphics processing unit 8041 processes static pictures or video image data obtained by an image capturing device (such as a camera) in a video capturing mode or an image capturing mode. The display unit 806 may include a display panel 8061, and the display panel 8061 may be configured by using a liquid crystal display, an organic light-emitting diode, or the like. The user input unit 807 includes at least one of a touch panel 8071 and another input device 8072. The touch panel 8071 is also referred to as a touch screen. The touch panel 8071 may include two parts: a touch detection apparatus and a touch controller. The another input device 8072 may include, but is not limited to, a physical keyboard, a functional key (such as a volume control key or a switch key), a track ball, a mouse, and a joystick, which are not described herein again.

In this embodiment of this application, after receiving downlink data from a network side device, the radio frequency unit 801 transmits the downlink data to the processor 810 for processing; and additionally, the radio frequency unit 801 may send uplink data to the network side device. Generally, the radio frequency unit 801 includes, but is not limited to, an antenna, an amplifier, a transceiver, a coupler, a low noise amplifier, a duplexer, and the like.

The memory 809 may be configured to store a software program or instructions and various data. The memory 809 may mainly include a first storage area storing a program or instructions and a second storage area storing data, where the first storage area may store an operating system, an application program or instructions required by at least one function (such as a sound playing function or an image playing function), and the like. In addition, the memory 809 may include a volatile memory or a non-volatile memory. Alternatively, the memory 809 may include both a volatile memory and a non-volatile memory. The non-volatile memory may be a read-only memory (Read-Only Memory, ROM), a programmable ROM (Programmable ROM, PROM), an erasable PROM (Erasable PROM, EPROM), an electrically EPROM (Electrically EPROM, EEPROM), or a flash memory. The volatile memory may be a random access memory (Random Access Memory, RAM), a static RAM (Static RAM, SRAM), a dynamic RAM (Dynamic RAM, DRAM), a synchronous DRAM (Synchronous DRAM, SDRAM), a double data rate SDRAM (Double Data Rate SDRAM, DDRSDRAM), an enhanced SDRAM (Enhanced SDRAM, ESDRAM), a synch link DRAM (Synch link DRAM, SLDRAM), or a direct rambus RAM (Direct Rambus RAM, DRRAM). The memory 809 in this embodiment of this application includes, but is not limited to, these memories and any other suitable types of memories.

The processor 810 may include one or more processing units. Optionally, the processor 810 integrates an application processor and a modem processor, where the application processor mainly processes an operation involving the operating system, the user interface, the application program, and the like, and the modem processor mainly processes a wireless communication signal, for example, a baseband processor. It may be understood that the foregoing modem processor may alternatively not be integrated into the processor 810.

The processor 810 is configured to obtain a frequency domain resource, where the frequency domain resource is located in at least one type of the following frequency bands: an uplink frequency band for frequency division duplex, a supplementary uplink frequency band, and an ultra high-frequency frequency band; and
the radio frequency unit 801 is configured to perform first transmission on the frequency domain resource, where the first transmission includes at least one of the following:
transmission of a control command;
transmission of a carrier wave signal; and
transmission of backscatter information.

The terminal performs the first transmission in at least one type of frequency band of the UL frequency band for FDD, the SUL frequency band, and the UHF frequency band, and the first transmission includes at least one of the transmission of the control command, the transmission of the carrier wave signal, and the transmission of the backscatter information, to complete BSC sending and/or receiving. Because the frequency domain resource used in the first transmission is located in at least one type of frequency band of the UL frequency band for FDD, the SUL frequency band, and the UHF frequency band, NR downlink transmission on a FDD downlink spectrum can be not occupied and interfered.

Optionally, the frequency domain resource includes a first sub-frequency domain resource and a second sub-frequency domain resource, where the first sub-frequency domain resource is used for transmission of at least one of the control command and the carrier wave signal, and the second sub-frequency domain resource is used for the transmission of the backscatter information.

Optionally, the first sub-frequency domain resource and the second sub-frequency domain resource are located in a same frequency band, or the first sub-frequency domain resource and the second sub-frequency domain resource are located in different frequency bands.

Optionally, the first sub-frequency domain resource and the second sub-frequency domain resource are non-consecutive and/or non-overlapping.

Optionally, a frequency domain interval between the first sub-frequency domain resource and the second sub-frequency domain resource is greater than or equal to a first threshold.

Optionally, a frequency of the first sub-frequency domain resource is higher than a frequency of the second sub-frequency domain resource.

Optionally, a bandwidth of the frequency band in which the frequency domain resource is located is greater than or equal to a second threshold.

Optionally, the radio frequency unit 801 is further configured to:
report first capability information, where
the first capability information includes indication information about whether the first device supports simultaneously performing the first transmission and second transmission, where the second transmission includes new radio NR transmission and/or sidelink transmission.

Optionally, in a case that the first device supports simultaneously performing the first transmission and the second transmission, a frequency band in which the frequency domain resource is located is a con-current operating frequency band.

Optionally, the first device includes: at least one of a terminal device and a network side device.

Optionally, the control command includes at least one of the following: a select command, a query command, and an access command; and the backscatter information is the information triggered by the control command.

Optionally, the control command and the carrier wave signal are sent by at least one terminal device and/or at least one network side device.

An embodiment of this application further provides a network side device, including a processor and a communication interface, where the processor is configured to obtain a frequency domain resource, where the frequency domain resource is located in at least one type of the following frequency bands: an uplink frequency band for frequency division duplex, a supplementary uplink frequency band, and an ultra high-frequency frequency band; and the communication interface is configured to perform first transmission on the frequency domain resource, where the first transmission includes at least one of the following: transmission of a control command; transmission of a carrier wave signal; and transmission of backscatter information. The network side device embodiment corresponds to the foregoing method embodiment of the first device side, each implementation process and manner of the foregoing method embodiment is applicable to the network side device embodiment, and the same technical effects can be achieved.

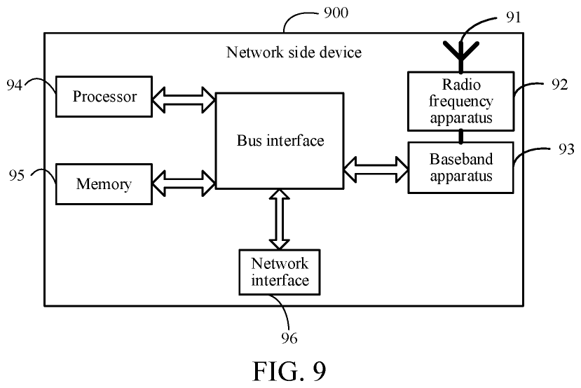

Specifically, an embodiment of this application further provides a network side device. As shown in FIG. 9, a network side device 900 includes: an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91 and sends the received information to the baseband apparatus 93 for processing. In a downlink direction, the baseband apparatus 93 processes the information to be sent and sends processed information to the radio frequency apparatus 92. The radio frequency apparatus 92 processes received information and sends processed received information out through the antenna 91.

The method performed by the network side device in the above embodiments may be implemented in the baseband apparatus 93, where the baseband apparatus 93 includes a baseband processor.

The baseband apparatus 93 may, for example, include at least one baseband board, where a plurality of chips are disposed on the baseband board. As shown in FIG. 9, one of the chips is, for example, the baseband processor, connected with the memory 95 through a bus interface to invoke a program in the memory 95 to perform network device operations shown in the above method embodiments.

The network side device may further include a network interface 96, and the interface is, for example, a common public radio interface (common public radio interface, CPRI).

Specifically, the network side device 900 of this embodiment of this application further includes: instructions or a program stored in the memory 95 and runnable on the processor 94, and the processor 94 invokes the instructions or the program in the memory 95 to perform the method performed by the modules shown in FIG. 5, and achieves the same technical effects. Details are not described herein again to avoid repetition.

An embodiment of this application further provides a readable storage medium, storing a program or instructions, where when the program or the instructions are executed by a processor, each process of the transmission processing method embodiments performed by the foregoing first device or the tag device is implemented, and the same technical effects can be achieved. Details are not described herein again to avoid repetition.

The processor is the processor in the terminal described in the above embodiment. The readable storage medium includes a computer-readable storage medium, for example, a computer read-only memory ROM, a random access memory RAM, a magnetic disk, or an optical disk.

An embodiment of this application additionally provides a chip, including a processor and a communication interface, where the communication interface is coupled to the processor, and the processor is configured to run a program or instructions to implement each process of the foregoing transmission processing method performed by the first device or the tag device, and the same technical effects can be achieved. Details are not described herein again to avoid repetition.

It is to be understood that the chip mentioned in this embodiment of this application may also be referred to as a system-level chip, a system chip, a chip system, an SoC chip, or the like.

An embodiment of this application additionally provides a computer program/program product, where the computer program/program product is stored in a storage medium, and the computer program/program product is executed by at least one processor to implement each process of the transmission processing method embodiments performed by the foregoing first device or the tag device, and the same technical effects can be achieved. Details are not described herein again to avoid repetition.

An embodiment of this application further provides a transmission processing system, including a first device and a tag device, where the first device may be configured to perform the steps of the foregoing method of a first device side, and the tag device may be configured to perform the steps of the foregoing method of a tag device side.

It is to be noted that, the term “comprise”, “include” or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the process, method, object, or apparatus. In addition, it is to be noted that, the scope of the method and apparatus in the embodiments of this application is not limited to performing the functions in the order shown or discussed, but may also include performing the functions in a substantially simultaneous manner or in a reverse order according to the functions involved, for example, the described method may be performed in a sequence different from the described order, and various steps may also be added, omitted, or combined. In addition, features described with reference to certain examples may be combined in other examples.

Through the descriptions of the foregoing implementations, a person skilled in the art may clearly understand that the method according to the foregoing embodiments may be implemented by means of software and a necessary general hardware platform, and certainly, may also be implemented by hardware, but in many cases, the former manner is a better implementation. Based on such an understanding, the technical solutions of this application essentially or the part contributing to the related art may be implemented in a form of a computer software product. The computer software product is stored in a storage medium (such as a ROM/RAM, a magnetic disk, or an optical disk) and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific embodiments, which are merely illustrative rather than limited. Under the inspiration of this application, a person of ordinary skill in the art can make many forms without departing from the scope of this application and the protection of the claims, all of which fall within the protection of this application.

What is claimed is:

1. A transmission processing method, comprising:
obtaining, by a first device, a frequency domain resource, wherein the frequency domain resource is located in at least one type of the following frequency bands: an uplink frequency band for frequency division duplex, a supplementary uplink frequency band, and an ultra high-frequency frequency band; and
performing, by the first device, a first transmission on the frequency domain resource, wherein the first transmission comprises at least one of the following:
transmission of a control command;
transmission of a carrier wave signal; and
transmission of backscatter information.

2. The method according to claim 1, wherein the frequency domain resource comprises a first sub-frequency domain resource and a second sub-frequency domain resource, wherein the first sub-frequency domain resource is used for transmission of at least one of the control command and the carrier wave signal, and the second sub-frequency domain resource is used for the transmission of the backscatter information.

3. The method according to claim 2, wherein the first sub-frequency domain resource and the second sub-frequency domain resource are located in a same frequency band, or the first sub-frequency domain resource and the second sub-frequency domain resource are located in different frequency bands, or
wherein the first sub-frequency domain resource and the second sub-frequency domain resource are at least one of non-consecutive or non-overlapping; or
wherein a frequency domain interval between the first sub-frequency domain resource and the second sub-frequency domain resource is greater than or equal to a first threshold; or
wherein a frequency of the first sub-frequency domain resource is higher than a frequency of the second sub-frequency domain resource.

4. The method according to claim 1, further comprising:
reporting, by the first device, first capability information, wherein
the first capability information comprises indication information about whether the first device supports simultaneously performing the first transmission and second transmission, wherein the second transmission comprises at least one of New Radio (NR) transmission or sidelink transmission.

5. The method according to claim 4, wherein in a case that the first device supports simultaneously performing the first transmission and the second transmission, a frequency band that the frequency domain resource is located in is a con-current operating frequency band.

6. The method according to claim 1, wherein the first device comprises: at least one of a terminal device and a network side device.

7. The method according to claim 1, wherein the control command comprises at least one of the following: a select command, a query command, and an access command; and the backscatter information is the information triggered by the control command.

8. The method according to claim 1, wherein the control command and the carrier wave signal are sent by at least one of at least one terminal device or at least one network side device.

9. A transmission processing method, comprising:
obtaining, by a tag device, a frequency domain resource, wherein the frequency domain resource is located in at least one type of the following frequency bands: an uplink frequency band for frequency division duplex, a supplementary uplink frequency band, and an ultra high-frequency frequency band; and
performing, by the tag device, a first transmission on the frequency domain resource, wherein the first transmission comprises at least one of the following:
transmission of a control command;
transmission of a carrier wave signal; and
transmission of backscatter information.

10. The method according to claim 9, wherein the frequency domain resource comprises a first sub-frequency domain resource and a second sub-frequency domain resource, wherein the first sub-frequency domain resource is used for transmission of at least one of the control command and the carrier wave signal, and the second sub-frequency domain resource is used for the transmission of the backscatter information.

11. The method according to claim 10, wherein the first sub-frequency domain resource and the second sub-frequency domain resource are located in a same frequency band, or the first sub-frequency domain resource and the second sub-frequency domain resource are located in different frequency bands; or
wherein the first sub-frequency domain resource and the second sub-frequency domain resource are at least one of non-consecutive or non-overlapping; or
wherein a frequency domain interval between the first sub-frequency domain resource and the second sub-frequency domain resource is greater than or equal to a first threshold; or
wherein a frequency of the first sub-frequency domain resource is higher than a frequency of the second sub-frequency domain resource.

12. The method according to claim 9, further comprising:
reporting, by the tag device, second capability information, wherein
the second capability information comprises indication information about whether the tag device supports simultaneously performing the first transmission and second transmission, wherein the second transmission comprises at least one of New Radio (NR) transmission or sidelink transmission.

13. The method according to claim 12, wherein in a case that the tag device supports simultaneously performing the first transmission and the second transmission, a frequency band in which the frequency domain resource is located is a con-current operating frequency band, wherein
the second transmission comprises at least one of the NR transmission or the sidelink transmission.

14. The method according to claim 9, wherein sending, by the tag device, the backscatter information in a backscatter manner or an actively sending manner.

15. The method according to claim 9, wherein the tag device satisfies at least one of the following:
being an active device or a semi-passive device; and
having a capability for a frequency shift, wherein the frequency shift refers to the frequency shifting between a transmitting frequency and a receiving frequency.

16. The method according to claim 9, wherein the control command comprises at least one of the following: a select command, a query command, and an access command; and the backscatter information is the information triggered by the control command.

17. The method according to claim 9, wherein the control command and the carrier wave signal are sent by at least one of at least one terminal device or at least one network side device.

18. A communication device, comprising:
at least one hardware processor and a memory, wherein the memory stores a program or instructions runnable on the processor, and when the program or the instructions are executed by the processor, the communication device is caused to:
obtain a frequency domain resource, wherein the frequency domain resource is located in at least one type of the following frequency bands: an uplink frequency band for frequency division duplex, a supplementary uplink frequency band, and an ultra high-frequency frequency band; and
perform first transmission on the frequency domain resource, wherein the first transmission comprises at least one of the following:
transmission of a control command;
transmission of a carrier wave signal; and
transmission of backscatter information.

19. A communication device, comprising at least one hardware processor and a memory, wherein the memory stores a program or instructions runnable on the processor, and when the program or the instructions are executed by the processor, the communication device is caused to perform the transmission processing method according to claim 9.

20. A non-transitory computer-readable storage medium storing a program or instructions, and when the program or the instructions are executed by at least one hardware processor, the transmission processing method according to claim 1 is implemented.
